(19) United States
(12) Patent Application Publication
(10) Pub. No.: US 2007/0022558 A1
(43) Pub. Date: Feb. 1, 2007

(54) Method and apparatus for improving windshield wiper performance using a vibrating windshield wiper blade

(75) Inventors: Krassimir D. Petkov, Sudbury, MA (US); Gunter Erdmann, Medway, MA (US); Rolf D. Seichter, Gilford, NH (US)

Correspondence Address: Robert K. Tendler, 65 Atlantic Avenue, Boston, MA, 02110, US

(73) Assignee: ACOM International, Inc.

(21) Appl. No.: 11/189,501

(22) Filed: Jul. 26, 2005

(51) Int. Cl. B60S 1/04; B60S 1/06; B60S 1/44; B60S 1/32

(52) U.S. Cl. 15/250.361; 15/250.001; 15/250.48

(57) ABSTRACT

A method is provided for improving the wiping capabilities of a windshield wiper by causing the windshield wiper blade to vibrate or oscillate in a direction parallel to the longitudinal centerline of the blade during a windshield wiper sweep. The vibrating mode causes less wear on the blade due to windshield abrasion since the blade edge does not contact the same eroded point on the windshield all the time. Secondly, any debris that is caught underneath the blade is quickly ejected due to the vibrating action. In one embodiment, an electromechanical vibrating unit is secured at one or more positions to the blade, with the actuator being driven by a 12-volt source and provided with a quickie disconnect at the center of the blade support structure. The vibrating actuator may be an electromechanically drive off-centered weight, a vibrating linear actuator, an ultrasonic vibrator, or a vibrator in the form of a piezoelectric crystal, with the primary mode of oscillation translating the blade along its centerline. The result is that debris underneath the blade is thrown out, including leaf stems, leaves and particulate matter, with the periodic translation of the blade providing more uniform water removal during the wiping operation to provide clearer visibility through the windshield regardless of the amount of water on the windshield, whether it be from a sporadic sprinkle or a torrential downpour. Wiper life is extended since the blade edge's position on the windshield is constantly varied during wiper sweeps.

### FIELD OF THE INVENTION

This invention relates to the cleaning of windshields and more particularly to a vibrating windshield wiper.

### BACKGROUND OF THE INVENTION

Windshield wipers having flexible rubber blades have been used to clear windshields. In general, the windshield wipers execute an arcuate sweeping path to provide an area on the windshield that can be cleared of water to permit viewing through the windshield.

As is well known, windshield wipers are not necessarily efficient at removing water to provide a clean sweep due to the wear of the blade edge from erosion. The erosion can be due to the friction of the blade over the windshield surface or from particulate matter that is on the windshield surface itself. Moreover, for older windshields the windshield surface becomes abraded, providing a rough surface over which the blade rubs.

In any case, the repetitive sweeping motion of the blade over the windshield, when encountering a surface discontinuity, wears the blade edge at the point at which the discontinuity touches the edge of the blade. Since this discontinuity is always in the same place, the part of the blade that contacts the discontinuity does so at each sweep, thus to pit the blade at the position of contact.

This results in serrations on the blade edge due to wear, both because of the frictional forces on the blade during the sweep and because of the presence of discontinuities that are at the same position along the blade during the sweep.

In addition to the wearing or abrasion of the blade edge that causes streaking across the windshield and thus poor visibility, the efficiency of the windshield wiper for wiping or squeegeeing out water on the windshield's surface decreases when the volume of water is not large, such as for sporadic sprinkles or light rain.

In the past, intermittent windshield wipers have been developed to allow sufficient accumulation of water on the windshield to be able to efficiently squeegee it off without streaking. The streaking is oftentimes due to the bouncing of the windshield wiper on a dry windshield due to the frictional forces associated with the dry windshield. It is noted that the frictional forces significantly decrease with an increase in the amount of water on the windshield, making the clearing of the windshield streakless.

Thus whenever there is insufficient water, heretofore there has been no way to distribute whatever water there is over the blade edge to reduce the friction that causes streaking, with the streaking only eliminated when sufficient water exists along the entire length of the wiper blade.

Thus even with intermittent windshield wipers there may be insufficient water between sweeps to provide adequate lubrication for the blade. Thus even intermittently operated windshield wipers can streak when there is insufficient water on the windshield.

### SUMMARY OF INVENTION

In order to minimize blade wear and erosion and to distribute water evenly over the wiper blade even in cases where there would ordinarily be insufficient water on the blade, in the subject invention the windshield wiper blade is vibrated such that the windshield wiper blade translates cyclically along the longitudinal axis thereof. The result is that any water that is present between the windshield wiper blade and the windshield is evenly distributed over the blade to minimize blade drag and to eliminate streaking even during sprinkles which would ordinarily be smeared across the windshield to obstruct vision.

Importantly, since the blade is cyclically translated along its longitudinal axis during a sweep, there is no one position on the blade that repeatedly contacts the same windshield discontinuity such that pitting of the blade by the windshield discontinuity is minimized.

Moreover, the drag on the blade is further reduced by the vibrational mode of operation, with the reduced frictional drag also minimizing wear on the blade regardless of any windshield discontinuities.

Additionally, any debris such as leaf stems, insects or other particulate matter is more efficiently ejected from underneath the blade due to the blade vibration during each sweep.

The net result of all of the above action is the streakless cleaning of the windshield in a wide variety of conditions, with the vibration providing more efficient cleaning of the windshield.

In one embodiment, it has been found that the blade oscillation frequency is most efficient at around 400 Hz, utilizing a mechanically actuated vibrating module that provides sufficient amplitude oscillators of the blade along its longitudinal axis.

In order to permit blade movement along its longitudinal axis, in one embodiment loose-fit pinions support the blade on its blade mount.

While a single vibrating unit placed at or in the blade is sufficient to provide appropriate vibrating activity, multiple modules may be placed along the blade, with the modules operating in phase to provide the required vibrational mode.

Although the subject invention has been described in terms of longitudinal vibration of the blade, lateral vibrations may accompany the longitudinal vibration, with the added advantage of overcoming any blade stiffness that prevents one portion of the blade from standing off from the windshield, with the blade vibration introducing mechanical energy into the blade to soften it should it become deformed. Thus blades that have become deformed for one reason or another due, for instance, to cold weather, may be made more flexible by the vibrating mode.

As to the types of vibrating units, one can use a pill-shaped electromechanical offset weight capsule powered, for instance, by the 12-volt source of the vehicle, with the offset weight mounted on a motor shaft that runs transverse to the longitudinal axis of the blade. This capsule may be embedded in each replacement blade, with a quick disconnect being provided in the blade mount for electrical connections.

In one embodiment the wires for providing power may be conveniently routed through or along the washer tube that extends to the blade mount, with power conveniently available at the windshield washer pump.

Alternatively, one can use ultrasonic or piezoelectric transducers to vibrate the blade, with the transducers being embedded in the replacement blade if desired.

In addition to offset weight vibrating units, the longitudinal vibration may be provided by a reciprocating shaft with a solenoid-type of arrangement or may be provided by any mechanical form of device.

In summary, a method is provided for improving the wiping capabilities of a windshield wiper by causing the windshield wiper blade to vibrate or oscillate in a direction parallel to the longitudinal centerline of the blade during a windshield wiper sweep. The vibrating mode causes less wear on the blade due to windshield abrasion since the blade edge does not contact the same eroded point on the windshield all the time. Secondly, any debris that is caught underneath the blade is quickly ejected due to the vibrating action. In one embodiment, an electromechanical vibrating unit is secured at one or more positions to the blade, with the actuator being driven by a 12-volt source and provided with a quickie disconnect at the center of the blade support structure. The vibrating actuator may be an electromechanically drive off-centered weight, a vibrating linear actuator, an ultrasonic vibrator, or a vibrator in the form of a piezoelectric crystal, with the primary mode of oscillation translating the blade along its centerline. The result is that debris underneath the blade is thrown out, including leaf stems, leaves and particulate matter, with the periodic translation of the blade providing more uniform water removal during the wiping operation to provide clearer visibility through the windshield regardless of the amount of water on the windshield, whether it be from a sporadic sprinkle or a torrential downpour. Wiper life is extended since the blade edge's position on the windshield is constantly varied during wiper sweeps.

### BRIEF DESCRIPTION OF THE DRAWINGS

These and other features of the subject invention will be better understood in connection with a Detailed Description, in conjunction with the Drawings, of which:

FIG. 1 is a diagrammatic illustration of the streaking of a windshield by the windshield wipers due to the presence of debris on the windshield or due to an irregular or worn windshield wiper blade edge;

FIG. 2 is a diagrammatic illustration of the longitudinal oscillation or vibration of the windshield wiper blade during a windshield wiper sweep;

FIG. 3 is a diagrammatic illustration of an off-center weight vibrating unit or module for use in providing the longitudinal vibration of the windshield wiper blade of FIG. 2;

FIG. 4 is a diagrammatic illustration of a replacement windshield wiper blade having the module of FIG. 3 installed at the center thereof and connected electrically to the vehicle's electrical system via a line along the windshield wiper support arm;

FIG. 5 is a diagrammatic illustration of an alternative vibrating unit or module in which a motor translates a rod in an oscillatory motion to provide the requisite windshield wiper blade oscillation;

FIG. 6 is a diagrammatic illustration of the use of the vibration unit or module of FIG. 5 at the center of a replacement windshield wiper blade;

FIG. 7 is a diagrammatic illustration of the existence of a single droplet of water on the surface of a windshield prior to being swept by an adjacent windshield wiper blade;

FIG. 8 is a diagrammatic illustration of the effect of longitudinally vibrating the windshield wiper blade of FIG. 7 so as to spread the droplet;

FIG. 9 is a diagrammatic illustration of the formation of a thin film from the droplet of FIG. 7 due to the longitudinal oscillation of the windshield wiper blade of FIG. 7;

FIG. 10 is a diagrammatic illustration of the streaking caused by a single droplet on the surface of a windshield;

FIG. 11 is a diagrammatic illustration of the broadened smear of the single droplet of FIG. 10 that has been broadened by the oscillation of the windshield wiper blade;

FIG. 12 is a diagrammatic illustration of a no-smear zone due to the uniform film developed by the longitudinal vibration of the windshield wiper blade;

FIG. 13 is a diagrammatic illustration of a fixed discontinuity on the surface of a windshield that causes a pit at an adjacent location on the windshield wiper blade edge due to repetitive sweeps of the windshield wiper blade over the fixed discontinuity;

FIG. 14 is a diagrammatic illustration of the effect of oscillating the blade in a longitudinal direction, indicating uniform wear on the blade;

FIG. 15 is a diagrammatic illustration of an abraded windshield surface and wear of an adjacent blade edge due to the abrasive action of the windshield surface;

FIG. 16 is a diagrammatic illustration of the uniform wear associated with sweeping a windshield wiper blade over an abraded windshield surface;

FIG. 17 is a diagrammatic illustration of the presence of a leaf, stem or removable debris between the surface of the windshield and the windshield wiper blade;

FIG. 18 is a diagrammatic illustration of the ejection of the debris due to the longitudinal vibration of the windshield wiper blade; and,

FIG. 19 is a diagrammatic illustration of the use of flexible anchoring points to permit the windshield wiper blade to oscillate in the longitudinal direction.

### DETAILED DESCRIPTION

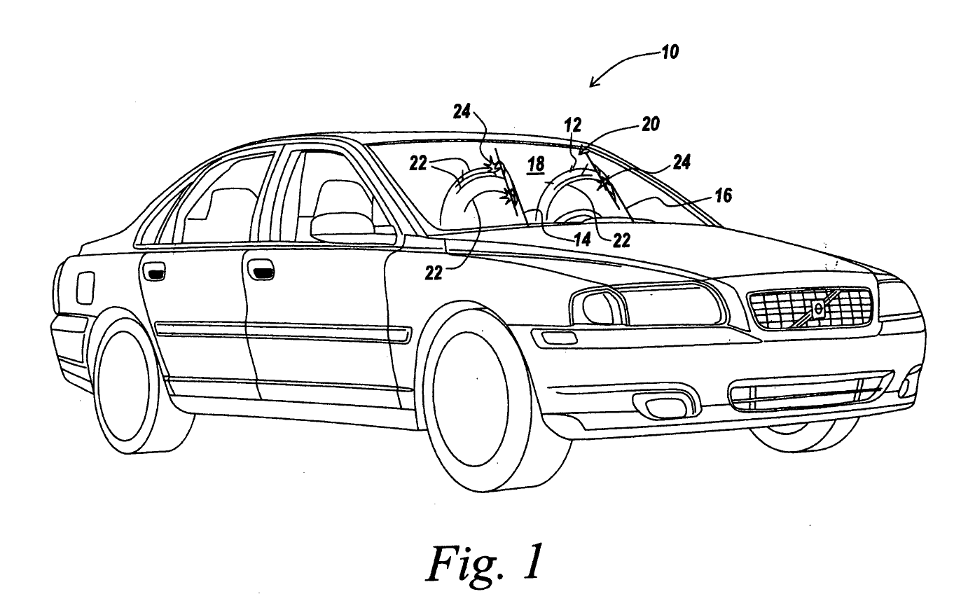

As illustrated in FIG. 1, a vehicle 10 is provided with a pair of windshield wiper blades 14 and 16, which sweep across the surface 18 of a windshield 20. Here it can be seen that various smears 22 occur when the windshield wiper blade, in an attempt to remove water on the surface of the windshield, either has an irregular edge due to wear or due to the presence of debris between the windshield surface and the wiper blade as illustrated by leaves 24; or is caused by insufficient liquid or moisture on the windshield, which causes the streaking.

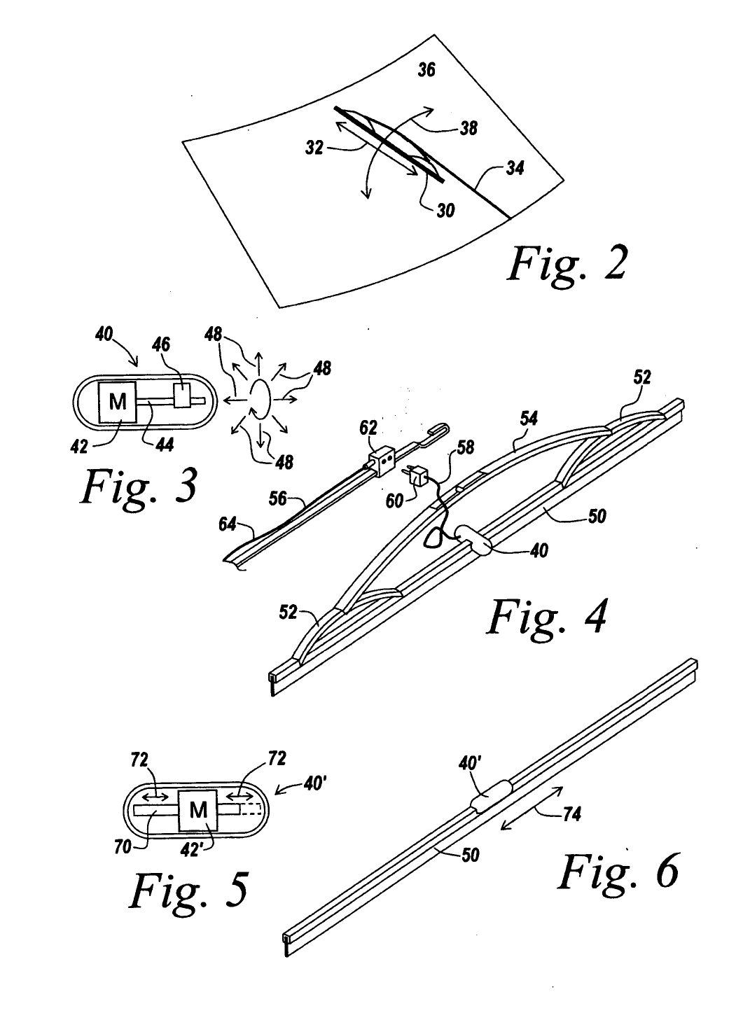

Referring now to FIG. 2 and in accordance with the subject invention, windshield wiper blade 30 is made to oscillate in the direction of double-ended arrow 32, which is along the longitudinal axis of the blade, as the corresponding windshield wiper 34 sweeps across a windshield 36 as illustrated by double-ended arrow 38. It is this longitudinal vibration or oscillation of the blade along its longitudinal centerline that provides for a number of advantages, both in the removal of water from the windshield and for the removal of debris as well as for the uniform wear of the blade to extend its life cycle.

Referring now to FIG. 3, in one embodiment a vibrator module or unit 40 includes a motor 42 from which a shaft 44 projects and on which is located an off-centered weight 46. The vibrational mode is illustrated by arrows 48 in which opposing arrows parallel to the longitudinal centerline of the wiper blade cause the windshield wiper blade to which it is attached to move in the aforementioned longitudinal direction. It will be appreciated with this vibrating module that other vibrations occur simultaneously. However, at least some of the vibrations cause the blade to move in the aforementioned longitudinal direction. Also other vibrational amplitudes have vectors along the longitudinal centerline of the wiper blade. Moreover it has been found that oscillations at or about 400 Hz are very effective, although other frequencies provide beneficial results.

Referring now to FIG. 4, module 40 may be integrally formed into a replacement blade 50, which is mounted as will be described on flexible mounts or anchoring points attached to arms 52, which are in turn attached to a supporting arm 54, in turn attached to wiper arm 56 in a conventional manner. Here an electrical line 58 with a plug 60 is plugged into a mating receptacle 62 on arm 56, with replacement 62 having wire 64 coupled to the vehicle power source, namely its battery.

Referring to FIG. 5, in an alternative form the vibrating module 40° here has its motor 42° actuate a rod 70 to translate backwards and forwards through motor 42° to provide for oscillation shown by double-ended arrow 72.

When module 40° is integrally formed with replacement blade 50, blade 50 is made to oscillate as illustrated by double-ended arrow 74 due to the translational vibration mode of rod 70.

Referring to FIG. 6, blade 50 has module 40° integrally formed therein to provide the longitudinal vibration indicated by double-ended arrow 74.

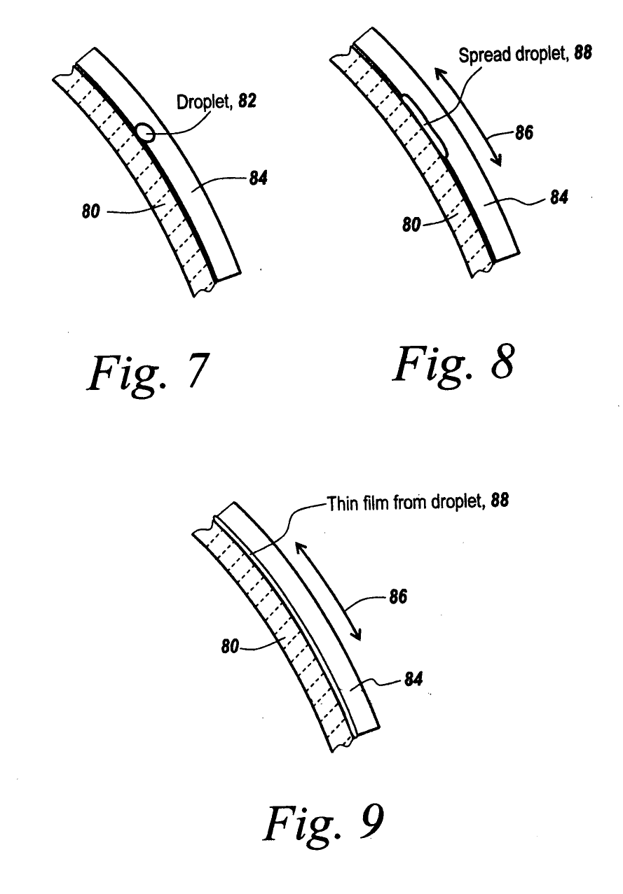

Referring now to FIG. 7, illustrating the case where there is very light rain or merely droplet spots on the windshield, windshield 80 is shown having a droplet 82 on the surface thereof adjacent windshield wiper blade 84.

Referring now to FIG. 8, blade 84 is vibrated along its longitudinal axis as illustrated by double-ended arrow 86 such that the original droplet is now spread to form a spread droplet as illustrated at 88.

Referring now to FIG. 9, upon numerous longitudinal oscillatory cycles as illustrated by double-ended arrow 86 of blade 84, a thin film 88 is formed from the droplet over the entire length of the edge of blade 84.

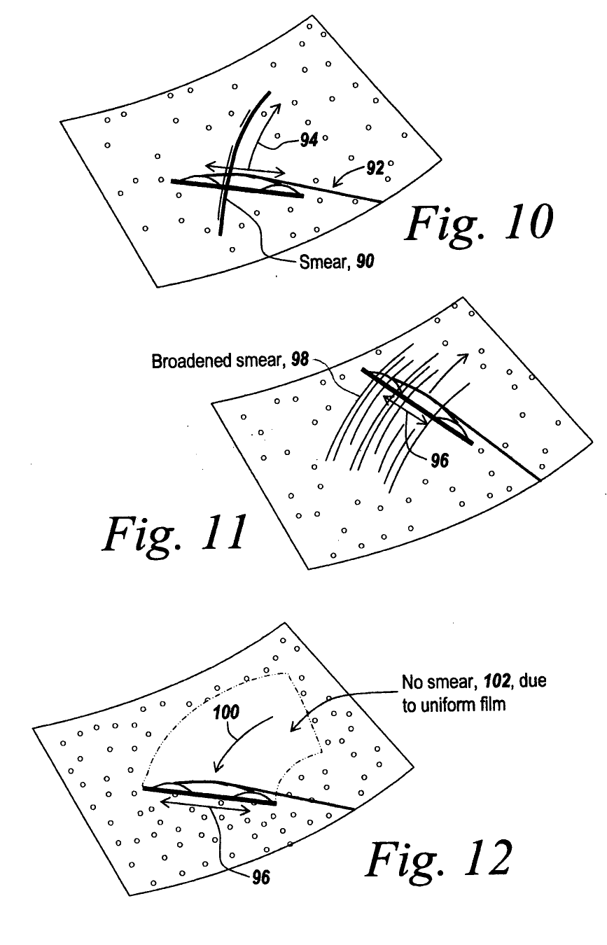

What is accomplished by the linear oscillation of the blade is to distribute what moisture existed in a very small droplet or set of droplets along the entire edge of the blade as the blade oscillates to provide blade lubrication and to prevent blade vibration or squeaking and subsequent streaking. The effect of the above is shown in FIG. 10, where the single droplet of FIG. 7 causes a smear 90 when windshield wiper 92 sweeps in the direction illustrated by arrow 94.

However, as illustrated in FIG. 11, when the oscillation as illustrated by double-ended arrow 96 occurs, the smeared-out droplet 88 of FIG. 8 now provides a broadened smear, here illustrated by 98.

As illustrated in FIG. 12, upon a number of oscillations of the windshield wiper blade as illustrated by double-ended arrow 96, a thin film from the droplet forms between the blade and the windshield to lubricate the blade as it sweeps across the windshield as illustrated by sweep 100 to form a no-smear zone 102 due to the uniform distribution of the liquid in the droplet.

What will be appreciated is that by the longitudinal vibration of the blade, any minimal moisture on the windshield will be distributed evenly across the blade edge to minimize drag, reduce friction and to provide a uniform, very thin film of moisture on the windshield that may be swept away by the blade edge due to the decreased coefficient of friction.

In this way, the problem of having windshield wipers that squeak and vibrate across the windshield due to insufficient moisture is now addressed by a mechanism by which whatever moisture exists at the blade is distributed along the edge of the blade to lubricate it, thus to eliminate smearing and squeaking in very light rain conditions.

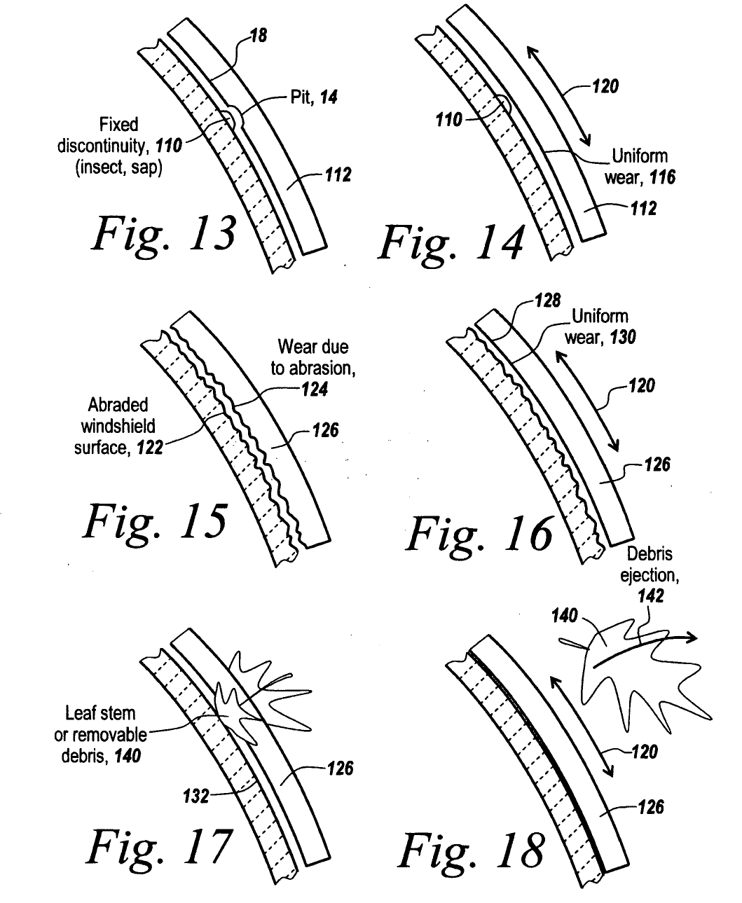

Moreover, as illustrated at FIG. 13, not only does the linear oscillation of the blade prevent smearing due to a light moisture, what can be seen is the effect of a fixed discontinuity 110 which may be caused by an insect or sap. This fixed discontinuity pits blade 112 at a pit point 114 due to the repeated crossing of the fixed discontinuity by the same portion of the edge 118 of blade 112.

Referring to FIG. 14, when such a situation occurs and the blade is oscillated as illustrated at 120, blade 112 wears evenly across the fixed discontinuity to provide a uniformly worn edge 116. This is due to the fact that no one portion of the wiper blade contacts the same discontinuity every time during a sweep.

Referring to FIG. 15, assuming that the windshield has an abraded windshield surface 122, the corresponding abraded edge 124 of blade 126 is worn in a pattern corresponding to the abraded windshield surface. Since most windshield surfaces abrade due to the collision with particulate matter during high-speed driving, wear due to abrasion such as illustrated at 124 is very commonplace and causes interruption in viewing through the windshield due to the smearing associated with the abraded windshield wiper edge.

However, as shown in FIG. 16, when the windshield wiper blade is oscillated along the longitudinal access of the blade, the edge 128 of blade 126 exhibits uniform wear as illustrated at 130, thus to prolong the lifetime of the blade. Thus longitudinal blade oscillation greatly extends wear life of the blade.

Additionally, as illustrated in FIG. 17, when a leaf or removable debris 140 exists between the windshield and blade 126, not only can the above-mentioned smearing or streaking occur due to the debris between the windshield surface 132 and blade 126, as illustrated in FIG. 18, with the longitudinal vibration of blade 126 the debris 140 is ejected as illustrated at 142. Thus the vibration of the windshield wiper helps to eject debris from between the blade and the windshield.

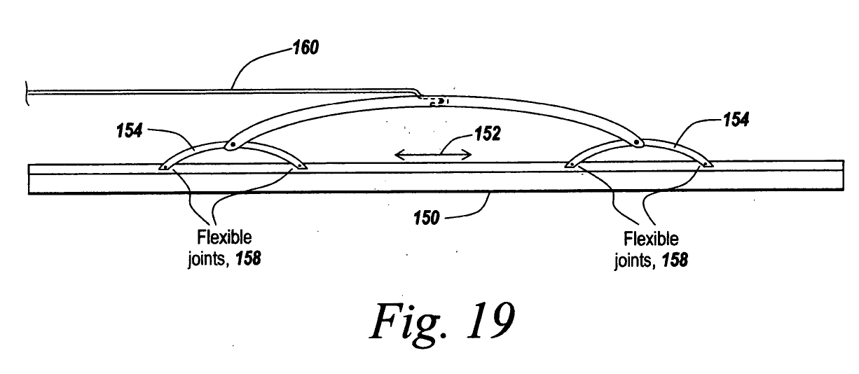

Referring now to FIG. 19, what is shown is a windshield wiper blade 150, which is vibrated by the above means as illustrated by double-ended arrow 152, with the blade being supported by arms 154 and 156, which have flexible anchoring points 158 at the extremities thereof.

These flexible joints can be oversized lost motion devices or can be simply flexible rubber connection points that allow blade 150 to vibrate in the longitudinal matter as illustrated by double-ended arrow 152.

In summary, what has been provided by the longitudinal movement or vibration of the blade during a sweep is that not only is there much more efficient cleaning of the windshield of water or other liquid, but also blade edge erosion and wear is minimized and debris between the windshield and the blade is more easily ejected during a windshield wipe sweep.

The oscillatory motion of the blade may be provided by integrally carried vibration modules, which may be connected to the vehicle's power supply by lines running along or through the windshield wiper arm, here illustrated at 160. Alternatively the vibrating modules may be affixed to installed blades.

While the subject invention has been described with one vibrating module per blade, multiple modules may be spaced along the blade if driven in phase.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

1. Apparatus for improving windshield wiper performance, comprising:
a windshield wiper blade;
a module coupled to said windshield wiper blade for causing longitudinal vibrations between 100 Hz and 1,000 Hz of said blade along the longitudinal centerline thereof such that said wiper blade moves cyclically back and forth along a line parallel to said longitudinal centerline, thus minimizing vibration transverse to said longitudinal centerline; and,
a module activator coupled to said module for causing said longitudinal vibrations when said windshield wiper is turned on to execute sweeps across a windshield.

2. (canceled)

3. The apparatus of claims 1, wherein said frequency is centered on 400 Hz.

4. The apparatus of claim 1, wherein said module includes a motor having a shaft and an offset weight on said shaft.

5. The apparatus of claim 4, wherein said module is coupled to said windshield wiper blade such that said shaft is at an angle to the centerline of said windshield wiper blade.

6. The apparatus of claim 5, wherein said angle is 90 degrees.

7. The apparatus of claim 1, wherein said module includes a reciprocating shaft.

8. The apparatus of claim 7, wherein said reciprocating shaft reciprocates parallel to the centerline of said windshield wiper blade.

9. The apparatus of claim 1, wherein said module includes a sonic transducer.

10. (canceled)

11. The apparatus of claim 1, wherein said module includes an electromechanical transducer.

12. The apparatus of claim 1, wherein said module includes a piezoelectric transducer.

13. The apparatus of claim 1, and further including a windshield wiper arm and means for attaching said windshield wiper blade to said arm in a flexible manner to permit said longitudinal vibrations.

14. The apparatus of claim 13, wherein said attaching means includes a resilient material.

15. The apparatus of claim 1, wherein said wiper blade is attached to a wiper arm and further including conductors to supply vehicle power to said module running adjacent said wiper arm.

16. The apparatus of claim 1, wherein said module is integral to said wiper blade.

17. The apparatus of claim 1, wherein said module is releasably attachable to said wiper blade.

18. The apparatus of claim 1, wherein said wiper blade is a removably detachable replacement blade.

19. The apparatus of claim 18, wherein said module is integral to said removably detachable blade.

20. A method of decreasing wear and extending the life of a windshield wiper blade, comprising the step of vibrating the wiper blade at between 100 Hz and 1,000 Hz so that it moves back and forth along its longitudinal centerline during windshield wiper sweeps, thus minimizing vibration transverse to the longitudinal centerline, whereby different portions of the edge of the blade contact a given spot on the windshield during successive sweeps.

21. (canceled)

22. A method for effectively removing water from the surface of a windshield by a windshield wiper during intermittent or low volume rain conditions that would ordinarily cause streaking, comprising the step of vibrating the wiper blade at between 100 Hz and 1,000 Hz so that it moves back and forth along its longitudinal centerline during windshield wiper sweeps, thus minimizing vibration transverse to the longitudinal centerline, whereby small amounts of water on the windshield are spread out in a thin film underneath the wiper blade to lubricate the blade and permit streak-free cleaning of the windshield.

23. (canceled)

24. A method of ejecting material lying between a windshield wiper blade and a windshield, comprising the step of vibrating the wiper blade so that it moves back and forth substantially only along its longitudinal centerline during windshield wiper sweeps, thus minimizing vibration transverse to the longitudinal centerline.
